(19) United States
(12) Patent Application Publication
(10) Pub. No.: US 2014/0269449 A1
(43) Pub. Date: Sep. 18, 2014

(54) FULL-DUPLEX WIRELESS TRANSCEIVER WITH HYBRID CIRCUIT AND RECONFIGURABLE RADIATION PATTERN ANTENNA

(71) Applicant: QUALCOMM INCORPORATED, San Diego, CA (US)

(72) Inventors: Victor Alexander ABRAMSKY, Edison, NJ (US); Michael Leonard LICCONE, Scotch Plains, NJ (US); Peter SUPRUNOV, Flemington, NJ (US); Shaun Joseph GREANEY, Freehold, NJ (US)

(73) Assignee: QUALCOMM INCORPORATED, San Diego, CA (US)

(21) Appl. No.: 13/841,712

(22) Filed: Mar. 15, 2013

(51) Int. Cl. H04L 5/14

(52) U.S. Cl. CPC H04L 5/14
USPC 370/278

(57) ABSTRACT

A method and circuit are provided that solve the problem of prolonged signal fading in transceivers utilizing dual antenna match in a hybrid transmitter-receiver cancellation circuit, thereby enabling practically implementable full-duplex single channel, or duplexerless frequency division duplex (FDD), wireless communication systems. The method includes controlling dynamic change in signal's amplitude and phase at the receiver port of a hybrid Tx-Rx circuit by continuously varying radiation pattern parameters of at least one antenna, while maintaining nearly constant impedance at the hybrid's antenna interface ports and equalizing propagation delays between the hybrid circuit and both antennas, using a novel circuit design.

### BACKGROUND

1. Field

The present disclosure relates to wireless transceivers, and more particularly, to full-duplex transceivers with hybrid circuits.

2. Background

Wireless communication systems are widely deployed to provide various types of communication content such as voice, data, video and the like, and deployments are likely to increase with introduction of new data oriented systems, such as Long Term Evolution (LTE) systems. Wireless communications systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP LTE systems and other orthogonal frequency division multiple access (OFDMA) systems. 3GPP LTE represents a major advance in cellular technology as an evolution of Global System for Mobile communications (GSM) and Universal Mobile Telecommunications System (UMTS).

Generally, a wireless multiple-access communication system can simultaneously support communication for a number of mobile entities, such as, for example, user equipments (UEs) or access terminals (ATs). A UE may communicate with a base station via the downlink and uplink. The downlink (or forward link) refers to the communication link from the base station to the UE, and the uplink (or reverse link) refers to the communication link from the UE to the base station. Such communication links may be established via a single-in-single-out, multiple-in-signal-out, or a multiple-in-multiple-out (MIMO) system. In MIMO systems, transceivers may share multiple (for example, two) transmit/receive antennas.

The foregoing and other wireless communications systems may make use of various components, including full-duplex transceivers. In a full-duplex transceiver, the transmit modem and receive modem perform simultaneous transmission and reception (STAR) at the same carrier frequency. Full-duplex operation may be subject to various technical challenges. For example, transmitted signals may interfere with signals that are received. These difficulties may be present in more complex MIMO full-duplex transceivers that include multiple shared transmit and receive antenna. One set of problems concerns isolation—the need to isolate the received signal from the transmitted signal. Various technical solutions for improving isolation in full-duplex transceivers, including MIMO transceivers, may exist in the art, for example hybrid circuits. In general, hybrid circuits are known in the art for converting and isolating signals between a transmission line and a UE or other equipment. In full-duplex MIMO transceivers, the hybrid circuit similarly enables sending and receiving signals on the same transmission medium. Notwithstanding the advantages of full-duplex MIMO transceivers using hybrid circuits, they may be subject to certain disadvantages, for example prolonged fading at the receive port under certain unpredictable signal conditions.

### SUMMARY

A full-duplex wireless transceiver with hybrid circuit and reconfigurable radiation pattern antenna is described in detail in the detailed description, and certain aspects are summarized below. Among other things, the described transceiver may be used to prevent or minimize prolonged signal fading at the receiver due to cancellation of the received signal at dual receive ports of the transceiver. This summary and the following detailed description should be interpreted as complementary parts of an integrated disclosure, which parts may include redundant subject matter and/or supplemental subject matter. An omission in either section does not indicate priority or relative importance of any element described in the integrated application. Differences between the sections may include supplemental disclosures of alternative embodiments, additional details, or alternative descriptions of identical embodiments using different terminology, as should be apparent from the respective disclosures.

The described technical solution may include a dual-antenna hybrid transmitter-receiver cancellation circuit, including a hybrid component coupled to a first antenna port and to a second antenna port. The hybrid component may be configured to isolate transmitted signals at a transmitter port of a full-duplex transceiver from received signals at a receiver port. The circuit may further include a configurable radiation pattern antenna coupled to one of the first antenna port and the second antenna port. The configurable antennas may include, for example, a tunable multi-element antenna wherein tuning involves connecting to different elements of the antenna, or a tunable movable antenna wherein tuning involved moving (e.g., rotating and/or expanding/contracting) a radiating element of the antenna.

The circuit may further include a control circuit controlling the configurable antenna based on a received radiation pattern so as to avoid signal cancellation at the receiver port, by varying at least one of amplitude and phase of signal at the one of the first antenna port and the second antenna port. The varying may be done at a relatively rapid, substantially constant or variable frequency, so as to be fairly describable as continuous. For example, the control circuit may change a radiation-pattern parameter of the antenna once about every 10 ms. As used herein, a radiation-pattern parameter means a parameter such as, for example, a radiation lobe direction, a radiation lobe shape, or a beam width. These and similar radiation parameters may be determined and controlled by physical properties of the antenna such as, for example, radiating element size, shape or orientation.

The circuit may also include a first phase shifting and impedance matching module interposed between the configurable antenna and the one of the first antenna port and the second antenna port. The first phase shifting and impedance matching module may include a network of delay/impedance compensation elements each designed to compensate for a corresponding state of the configurable antenna. The circuit may further include a second antenna coupled to another one of one of the first antenna port and the second antenna port, and a second phase shifting and impedance matching module interposed between the second antenna and the another one of one of the first antenna port and the second antenna port.

In another aspect, a method for operating a dual-antenna hybrid transmitter-receiver cancellation circuit in a full duplex transceiver may include varying at least one radiation pattern parameter of at least one configurable antenna of dual antennas in the antenna hybrid transmitter-receiver cancellation circuit, so as to cause a corresponding change in at least one of amplitude and phase of a signal received at a receiver port of the circuit. For example, the varying comprises adjusting the radiation pattern parameter at least once per period, wherein the period is in a range of about 2 to 200 msec, such as, for example, about 10 ms. Contemporaneously with the varying, the method may include maintaining nearly constant impedance at the hybrid circuit's antenna interface ports, and equalizing propagation delays between the hybrid circuit and both of the dual antennas.

In an aspect of the method, the radiation pattern parameter may be or may include at least one of a radiation lobe direction, a radiation lobe shape, or a beam width. The method may include varying the radiation pattern parameter by any suitable operation. For example, varying the at least one radiation pattern parameter may be performed by moving an antenna element. For further example, varying the at least one radiation pattern parameter may be performed by switching a connection between different antenna components and the receiver port. Because the method results in continuous or near-continuous variation in antenna radiation pattern parameters while maintaining constant impedance and equalizing propagation delays, prolonged fading due to signal cancellation at the receiver ports can be avoided. In general, fade durations due to signal cancellation may be reduced to, or less than, the duration of one parameter duration. Recurrences of the short fade may be increased by increasing the number of different radiation pattern parameters used in the control cycle. The periodicity of the fast fading pattern (i.e., the cycle of changes in antenna radiation parameters) may be constant or variable. Two or more wireless devices that establish a communication link may communicate their induced fading rate status and agree on a mutually beneficial fading rate, or on which device induces the fading.

In related aspects, a wireless communication apparatus may be provided for performing any of the methods and aspects of the methods summarized above. An apparatus may include, for example, a processor coupled to a memory, wherein the memory holds instructions for execution by the processor to cause the apparatus to perform operations as described above. Certain aspects of such apparatus (e.g., hardware aspects) may be exemplified by equipment such as a full-duplex wireless transceiver. Similarly, an article of manufacture may be provided, including a computer-readable storage medium holding encoded instructions, which when executed by a processor, cause a full-duplex wireless transceiver to perform the methods and aspects of the methods as summarized above.

### BRIEF DESCRIPTION OF THE DRAWINGS

FIG. 1 is a block diagram conceptually illustrating an example of a single-antenna full-duplex hybrid transceiver without a configurable antenna.

FIG. 2 is a block diagram conceptually illustrating an example of a dual-antenna full-duplex hybrid transceiver without a configurable antenna.

FIG. 3 is a block diagram conceptually illustrating an example of a dual-antenna full-duplex hybrid transceiver without a configurable antenna, including a phase shifter between a receiver port and one of the antennas.

FIG. 4 is a block diagram conceptually illustrating an example of a dual-antenna full-duplex hybrid transceiver without a configurable antenna, including phase shifters between both receiver ports and each of the antennas.

FIG. 5 is a block diagram conceptually illustrating an example of a dual-antenna full-duplex hybrid transceiver with a single configurable antenna, including phase shifters and impedance tuners between both receiver ports and each of the dual antennas.

FIG. 6 is a block diagram conceptually illustrating an example of a dual-antenna full-duplex hybrid transceiver with dual configurable antennas, including phase shifters and impedance tuners between both receiver ports and each of the dual antennas.

FIG. 7 is a block diagram illustrating a more detailed example of a dual-antenna full-duplex hybrid transceiver with a single configurable antenna, including a dual-antenna hybrid transmitter-receiver cancellation circuit.

FIG. 8 is a block diagram illustrating a system in which signal cancellation occurs at a receiver of a dual-antenna hybrid circuit.

FIG. 9 is a block diagram illustrating a system in which signal boosting is realized at a receiver of a dual-antenna hybrid circuit by introducing static phase shifting at one antenna.

FIG. 10A is a block diagram illustrating a system in which induced fading avoiding prolonged signal cancellation is realized at a receiver of a dual-antenna hybrid circuit by introducing variable phase shifting at one antenna.

FIG. 10B is a graph illustrating a received signal with induced fading as may be realized using the system of FIG. 10A.

FIG. 11 illustrates a methodology executable by a dual-antenna hybrid transmitter-receiver cancellation circuit for controlling a dual-antenna full-duplex hybrid transceiver with at least one configurable antenna.

FIG. 12 illustrates further aspects of the methodology of FIG. 11.

FIG. 13 shows an embodiment of dual-antenna hybrid transmitter-receiver cancellation circuit, in accordance with the methodology of FIG. 11.

In the detailed description that follows, like element numerals may be used to indicate like elements appearing in one or more of the figures.

### DETAILED DESCRIPTION

In a full-duplex single channel wireless communications system, a transceiver transmits and receives on the same frequency at the same time. In a duplexerless frequency division duplex (FDD) system, a transceiver transmits and receives on different frequencies at the same time. In either system, a hybrid circuit 100 as shown in FIG. 1 may be used to isolate a transmitter 102 from a receiver 104. To provide good isolation, a termination resistance load (RL) 106 provides impedance at port 4 that closely matches antenna 110 impedance at port 1 of the hybrid component 108. This implementation suffers from two major disadvantages: a large portion of transmitter power is wasted in RL 106, and it may be difficult or impractical to design an RL that closely matches antenna impedance over a wide range of frequencies.

Prior approaches to addressing these disadvantages include placing an identical antenna 206 at port 4, in place of RL 106, as shown in the hybrid circuit 200 at FIG. 2. Other components may be the same as circuit 100. However, this approach creates another major drawback in that the received signal strength at the receiver 202 depends on the relative phase and amplitude of the signal at the two antennas 210, 206. Therefore, under some amplitude/phase conditions such as multipath induced fading, the two antenna inputs will cancel at the receiver port (port 2), severely degrading reception.

One approach to mitigating this drawback may include introducing phase rotation to increase the rate of fading, resulting in shorter duration signal dips that can be handled by the modem's error correction subsystem, as shown in FIGS. 3 and 4. Either of the illustrated circuits 300, 400 may reduce fade duration; however, a practical bi-directional phase shifter 302, 402, 404 with low insertion loss and high power handling ability will introduce varying signal propagation delays at ports 1 and 4 of the hybrid 308, 408. In turn, the varying delays cause impedance mismatch at ports 1 and 4 and reduce cancellation of transmit signal antenna reflections, leading to severe degradation of hybrid's 308, 408 transmit-to-receive isolation.

A method and circuit are provided that solve the problem of prolonged signal fading in transceivers utilizing dual antenna match in a hybrid transmitter-receiver cancellation circuit, thereby enabling practically implementable full-duplex single channel, or duplexer-less frequency division duplex (FDD), wireless communication systems. The method includes controlling dynamic change in signal's amplitude and phase at the receiver port of a hybrid Tx-Rx circuit, while maintaining nearly constant impedance at the hybrid's antenna interface ports and equalizing propagation delays between the hybrid circuit and both antennas, using a novel circuit design.

The solution includes adding a selectable (tunable) multi-element antenna or a reconfigurable radiation pattern antenna to one or both antenna ports of a hybrid circuit, as well as a matched (to antenna) phase shifter or a phase shifter+impedance matching network to compensate for the delay and impedance differences between antenna elements or between different states of a tunable antenna, as illustrated by FIGS. 5 and 6. In FIG. 5, the transceiver system 500 may include a configurable antenna 506 attached to one of the receive ports 4 via an impedance tuner 508 and phase shifter 510. A conventional non-configurable antenna 516 may be connected to the other receiver port 1 via phase shifter 520 and impedance tuner 518. Control signals 502, 504 may be provided from a processor (not shown) to maintain nearly constant impedance at the hybrid's antenna interface ports and equalize propagation delays between the hybrid circuit and both antennas 516, 506. Other components may be similar to circuit 100. Referring to FIG. 6, the transceiver system 600 may be similar to system 500, but includes a second configurable antenna 616.

A more detailed practical implementation of the circuit 500 of FIG. 5 is shown in FIG. 7. A dual-antenna hybrid transmitter-receiver cancellation circuit 700 may include a hybrid component 702 coupled to a first antenna port 1 and to a second antenna port 4. The hybrid component 702 may be configured to isolate transmitted signals at a transmitter port 2 of a full-duplex transceiver from received signals at a receiver port 3. The circuit may further include a configurable radiation pattern antenna 704 coupled to the antenna port 4. The configurable antenna 704 may include, for example, a tunable multi-element antenna (as shown) wherein tuning involves connecting to different elements of the antenna, or a tunable movable antenna wherein tuning involved moving (e.g., rotating and/or expanding/contracting) a radiating element of the antenna.

The circuit 700 may further include a control circuit 706 controlling the configurable antenna 704 based on a received radiation pattern so as to avoid signal cancellation at the receiver port, by varying at least one of amplitude and phase of signal at the antenna port 4. The varying may be done at a relatively rapid, substantially constant or variable frequency, so as to nearly continuous. For example, the control circuit 706 may change a radiation-pattern parameter of the antenna once about every 10 ms. Radiation-pattern parameters may include as, for example, a radiation lobe direction, a radiation lobe shape, or a beam width. These and similar radiation parameters may be determined and controlled by physical properties of the antenna 704 such as, for example, radiating element size, shape or orientation. These may be varied by selecting different ones or different combinations of the elements on the antenna 704 via the phase shifter 708.

The circuit 700 may also include a first phase shifting and impedance matching module 708 interposed between the configurable antenna 704 and the antenna port 4. The first phase shifting and impedance matching module 708 may include a network of delay/impedance compensation elements each designed to compensate for a corresponding state of the configurable antenna 704. The circuit 700 may further include a second antenna 710 coupled to the antenna port 1, and a second phase shifting and impedance matching module 712 interposed between the second antenna 710 and the antenna port 1.

The power amplifier (PA) 714 signal at port 3 may be cancelled at differential port 2 and divided between ports 1 and 4. The amount of isolation between ports 3 and 2 may depend on the mismatch between (i) a combination of the impedance presented by antenna 710 (Ant1) and any elements between Ant1 and port 1 of the hybrid 702 (Z1) and (ii) a combination of impedance presented by antenna 704 (Ant2) and any elements between Ant2 and port 4 of the hybrid 702 (Z2). If the same amplitude/phase signal arrives at both antennas 710 and 704, and if the transfer functions of the elements located between each of the antennas and its respective hybrid input port are the same, the signal will cancel at the receiver port 2, degrading receive sensitivity.

The proposed circuit and method resolve the problem of received signal cancellation while preserving the impedance match and equalizing group delay to both active antennas, thus maintaining the hybrid circuit's 700 transmit-to-receive isolation and minimizing ports 3-2 scattering parameter. The problem of received signal cancellation is resolved by introducing the configurable antenna 704, such as a tunable multi-element antenna, and controlling the antenna configuration based on received radiation pattern to vary the amplitude and phase of the signals at ports 1 and 4 of the hybrid 702 so as to avoid signal cancellation at the receiver port 2.

In addition, group delay and impedance changes at ports 1 and 4 may be compensated by selecting an appropriate one of delay/impedance elements Dxx 716 of one or more phase shifter/impedance matching networks. Each of the delay/impedance compensation elements Dxx 716 shown in FIG. 7 may be designed to compensate for a corresponding antenna state of the configurable antenna 704, thereby enabling selection of an appropriate one of the Dxx elements at each antenna state change.

The disclosed hybrid circuits with one or more configurable antennas can also be of benefit for radio transmission. When transmitting, rapid-cycle varying of configuration of one or more transmit antennas may be used to induce corresponding rapid-cycle but recoverable fading at a receiver, while avoiding prolonged and irrecoverable fading. In addition, the disclosed phase shifting components may also be useful on the transmit side. By varying the phase of the signal provided to different transmit antennas, the transmitted radiation may be beamformed. In beamforming, phase differences in the signal from different antennas causes the transmitted energy to be selectively radiated in one or more particular directions, such as towards the known or supposed location of a receiving device. Particular algorithms for controlling phase differences to provide beamforming from multiple antennas are known in the art, and may be used to control phase shifters in the hybrid circuits disclosed herein.

FIG. 8 is a block diagram illustrating a system 800 in which signal cancellation of a signal from an antenna 822 of a transceiver 820 occurs at a receiver 802 of a dual-antenna hybrid circuit. As noted above, in a dual-antenna hybrid circuit the received signal strength at the receiver 802 may depend on the relative phase and amplitude of the signal at the two antennas 810, 806. Therefore, the two antenna inputs can cancel at the receiver port (port 2), making reception by the receiver 802 impossible. For example, a signal with a complex envelope Sₜₓ transmitted from the antenna 822 may be characterized by Ae^{jθ}, wherein A is an envelope or magnitude of the complex envelope of the signal Sₜₓ, e^{j} is the complex exponential representation of the in-phase and quadrature components of the bandpass signal (e^{(+/-jθ)}=cos θ+/−j sin θ), and θ is the angular phase of the transmitted signal. Based on this representation, the band-pass signal S(t) is defined by S(t)=A(t)cos(2πf_{c}t+θ(t)), where f_{c} is the carrier frequency of the signal, A and θ are time varying functions, and it is assumed that A is sufficiently static relative to a propagation time between transmitter and receiver and θ. At the first antenna 810, the received signal Sᵣₓ₁ may be represented by k₁*Ae^{(Jθ+φ1)}, wherein k₁ is an attenuation factor and φ₁ is a phase shift of the signal at the first receiving antenna. Similarly, the received signal Sᵣₓ₂ at the second antenna 806 may be represented by k₂*Ae^{(jθ+φ2)}. The signal received by the receiver 802 may be represented by S=Sᵣₓ₁−Sᵣₓ₂. Because the first antenna 810 and the second antenna 806 may be relatively close to one another, k₁ may equal k₂ and φ₁ may equal φ₂. Under those conditions, Sᵣₓ₁=Sᵣₓ₂ and the received signal S=0. Thus, reception is impossible so long as k₁=k₂ and φ₁=φ₂.

To alleviate signal cancellation, in the system 900 shown in FIG. 9, static phase shifting may be introduced between one antenna 906 and the receiver 902 of a dual-antenna hybrid circuit. A signal may be transmitted from an antenna 922 of the transceiver 920 and received at the first antenna 910 and second antenna 906. The signal received by the second antenna 906 may be phase shifted by a constant amount, for example 180° or π radians, by the phase shifter 904 before being provided to the receiver 902. As before the transmitted signal may be represented by a signal Sₜₓ transmitted from the antenna 922 and characterized by Ae^{(jθ)}. At the first antenna 910, the received signal Sᵣₓ₁ may be represented by k₁*Ae^{(jθ+φ1)}. Similarly, the received signal Sᵣₓ₂ at the second antenna 906 may be represented by k₂*Ae^{(jθ+φ2)}. However, signal received by the receiver 902 may be represented by S=Sᵣₓ₁−Sᵣₓ₂(ø) wherein ø represents the introduced phase shift and Sᵣₓ₂(ø)=k₂*Ae^{(jθ+φ2-ø)}. Because the first antenna 910 and the second antenna 906 may be relatively close to one another, k₁ may equal k₂ and φ₁ may equal φ₂. For ø=π radians, the received signal S at the receiver 902 may be boosted by about 3 dB relative to Sᵣₓ₁ due to the introduced phase shift ø.

However, the use of static phase shifting may be subject to prolonged fading under transmission conditions wherein the difference between φ₁ and φ₂ approaches for a relatively prolonged period (e.g., for a set of continuous data frames too numerous to recover by error correction). Under these conditions Sᵣₓ₁ is equal or nearly equal to Sᵣₓ₂(ø) and reception is again blocked at the receiver 902.

To avoid such prolonged fading, a fast periodic induced phase shift or in one antenna configuration may be introduced, as previously described. FIG. 10A shows a system 1000 in which induced fading avoids prolonged signal cancellation at a receiver 1002 of a dual-antenna hybrid circuit by introducing variable phase shifting at one antenna 1006. The periodicity of the phase shifting introduced by phase shifter 1004 or by an antenna pattern change as discussed in connection with FIGS. 5-7 provides a fast fade periodicity that may prevent signal loss due to prolonged fades. The transmitter 1020 may include a data source 1024, channel encoder 1026 (e.g., block coder or convolutional encoder and interleaver) and modulator/transmitter 1028 providing a data signal at antenna 1022. Conversely, the receiver 1002 receiving the wireless data signal may include a receiver and demodulator, channel decoder (e.g., block decoder or deinterleaver and convolutional decoder) and data sink (not shown).

A signal may be transmitted from an antenna 1022 of the transceiver 1020 and received at the first antenna 1010 and second antenna 1006. The signal received by the second antenna 1006 may be phase shifted by a time-varying amount ø(t) by a phase shifter 1004 before being provided to the receiver 1002. In the alternative, or in addition, the antenna 1006 configuration may be varied with time as described in connection with FIGS. 5-7 in a periodic fashion. As in systems 800 and 900, the transmitted signal strength in system 1000 may be represented by a signal strength Sₜₓ transmitted from the antenna 1022 may be characterized by Ae^{(jθ)}. At the first antenna 1010, the received signal strength Sᵣₓ₁ may be represented by k₁*Ae^{(jθ+φ1)}. Similarly, the received signal strength Sᵣₓ₂ at the second antenna 1006 may be represented by k₂*Ae^{(jθ+φ1)}. However, signal received by the receiver 1002 may be represented by S=Sᵣₓ₁−Sᵣₓ₂(ø(t)) wherein ø(t) represents the introduced periodic time-varying phase shift and Sᵣₓ₂(ø(t))=k₂*Ae^{(jθ+φ2-ø(t))}. Because the first antenna 1010 and the second antenna 1006 may be relatively close to one another, kₜ may equal k₂ and φ₁ may equal φ₂. The received signal S may exhibit a fast periodicity equal to the periodicity of the time

FIG. 10B is a graph 1050 illustrating a received signal S 1052 with induced periodic fading of periodicity 2π/ø as may be realized using the system of FIG. 10A. A phase shifter or antenna controller or both may be used to rotate the phase of incoming signal in a predictable periodic fashion. The fade duration (period of the rotation=2π/ø) may be selected based on the design of the channel encoder/decoder blocks, such that the channel bits that cannot be properly demodulated due to fading below an SNR threshold can be recovered through a channel decoding process using the properly demodulated bits. Properly demodulated bits may include, for example, those bits demodulated during the portion of the fast fading cycle wherein the signal strength is above the required SNR threshold (see FIG. 10B). Relevant background information on recovery of lost bits in a CDMA wireless system may be found, for example, in The Effect of Mobile Speed on The Forward Link of DS-CDMA Cellular System, by V. Weerackody, IEEE GLOBECOM Conference papers, 1995.

In view of example systems shown and described herein, methodologies that may be implemented in accordance with the disclosed subject matter, will be better appreciated with reference to various flow charts. While, for purposes of simplicity of explanation, methodologies are shown and described as a series of acts/blocks, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g., device, system, process, or component). Additionally, it should be further appreciated that methodologies disclosed throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

In accordance with one or more aspects of the embodiments described herein, with reference to FIG. 11, there is shown a methodology 1100, operable by a hybrid transmitter-receiver cancellation circuit of a full-duplex MIMO transceiver of a wireless communication device. Specifically, the method 1100 may involve, at 1110, varying at least one radiation pattern parameter of at least one configurable antenna of dual antennas in the antenna hybrid transmitter-receiver cancellation circuit, so as to cause a corresponding change in at least one of amplitude and phase of a signal received at a receiver port of the circuit. The method 1100 may involve, at 1120, hybrid transmitter-receiver cancellation circuit. The method 1100 may involve, at 1130, equalizing propagation delays between the hybrid circuit and both of the dual antennas. The operations 1110, 1120, 1130 may be performed contemporaneously to avoid fading ay the receiver port of the transceiver cause by signal cancellation.

Further aspects 1200 of the method 1100 are shown in FIG. 12. The aspects 1200 are optional, and may be performed in any operative order. The performance of any element of blocks 1200 does not imply the performance of any other upstream or downstream block included in blocks 1200. The method 1100 may include, at 1210, adjusting the radiation pattern parameter at least once per period, wherein the period is in a range of about 2 to 200 msec. For example, the parameters may be adjusted once per approximately 10 msec. The method 1100 may include, at 1220, varying the at least one radiation pattern parameter by moving an antenna element. For example, a motor under control of an antenna controller may change the position, orientation, shape or extension of a radiating element of the antenna. In the alternative, or in addition, the method 1100 may include, at 1230, varying the at least one radiation pattern parameter comprises switching a connection between different antenna components and the receiver port. For example, different elements of a tunable multi-element antenna may be selected via a phase shifter, as illustrated in FIG. 7.

The method 1100 may include, at 1240, selecting a periodicity of the varying the at least one radiation pattern parameter from the group consisting of: constant periodicity or variable periodicity. It is not necessary to vary periodicity of fading once it is established, so a periodic rate of fading may be initiated and then held constant. In the alternative, or in addition, periodicity may be varied over time either during an initiation phase or later, for example in response to changes in one or more parameters of the radio link.

Two or more wireless devices that establish a communication link may communicate their induced fading rate status and agree on a mutually beneficial fading rate, or on which device induces the fading. A mutually beneficial rate may be, or may include, a rate within the capabilities of at least one of the wireless devices to produce, at which the need to perform data recovery operations is minimized. The rate may be estimated from current parameters of the wireless link, discovered via an iterative empirical process, or determined by some combination of empirical and determinate processes. In a paired link it is sufficient for only one device to induce fading, because both Tx and Rx links experience same fading rate. Accordingly, the method 1100 may include, at 1250, communicating with a second wireless communication device to determine a mutually beneficial periodicity for varying the at least one radiation pattern parameter.

In accordance with one or more aspects of the embodiments described herein, there are provided devices and apparatuses for operating a full-duplex hybrid circuit to reduce received signal fading due to signal cancellation, as described above with reference to FIGS. 7 and 11. With reference to FIG. 13, there is provided an example apparatus 1300 that may be configured as a full-duplex hybrid circuit or the like, or as a processor or similar device/component for use said circuit.

The apparatus 1300 may include functional blocks that can represent functions implemented by a processor, software, or combination thereof (e.g., firmware). For example, apparatus 1300 may include an electrical component or module 1312 for varying at least one radiation pattern parameter of at least one configurable antenna of dual antennas in the antenna hybrid transmitter-receiver cancellation circuit, so as to cause a corresponding change in at least one of amplitude and phase of a signal received at a receiver port of the circuit. The apparatus 1300 may include a component 1314 for maintaining nearly constant impedance at the hybrid circuit's antenna interface ports. The apparatus 1300 may include a component 1316 for equalizing propagation delays between the hybrid circuit and both of the dual antennas.

The components 1312-1316 may comprise means for performing the described functions. More detailed algorithms for accomplishing the described functions are provided herein above, for example, in connection with FIG. 7.

In related aspects, the apparatus 1300 may optionally include a processor component 1310 having at least one processor, in the case of the apparatus 1300 configured as a transceiver controller. The processor 1310, in such case, may be in operative communication with the components 1312-1316 via a bus 1312 or similar communication coupling. The processor 1310 may effect initiation and scheduling of the processes or functions performed by electrical components 1312-1316.

In further related aspects, the apparatus 1300 may include a receiver port 1314 connected to a receiver component. The apparatus 1300 may optionally include a component for storing information, such as, for example, a memory device/component 1316. The computer readable medium or the memory component 1316 may be operatively coupled to the other components of the apparatus 1300 via the bus 1312 or the like. The memory component 1316 may be adapted to store computer readable instructions and data for effecting the processes and behavior of the components 1312-1316, and subcomponents thereof, or the processor 1310, or the methods disclosed herein. The memory component 1316 may retain instructions for executing functions associated with the components 1312-1316. While shown as being external to the memory 1316, it is to be understood that the components 1312-1316 can exist within the memory 1316. It is further noted that the components in FIG. 13 may comprise various components, for example, processors, electronic devices, hardware devices, electronic sub-components, logical circuits, memories, software codes, firmware codes, or any combination thereof.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and process steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or process described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more example designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage medium is a type of a non-transitory medium and may include any available storage medium that can be accessed by a general purpose or special purpose computer. By way of example, and not limitation, such computer-readable media can include RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Disk and disc, as used herein, includes compact disc (CD), laser disc, optical disc, digital versatile disc (DVD), floppy disk and blu-ray disc. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A dual-antenna hybrid transmitter-receiver cancellation circuit, comprising:
a hybrid component coupled to a first antenna port and to a second antenna port isolating transmitted signals at a transmitter port from received signals at a receiver port;
a configurable radiation pattern antenna coupled to one of the first antenna port and the second antenna port; and
a control circuit controlling the configurable antenna based on a received radiation pattern so as to avoid signal cancellation at the receiver port by varying at least one of amplitude and phase of signal at the one of the first antenna port and the second antenna port.

2. The circuit of claim 1, further comprising a first phase shifting and impedance matching module interposed between the configurable antenna and the one of the first antenna port and the second antenna port.

3. The circuit of claim 2, wherein the first phase shifting and impedance matching module comprises a network of delay/impedance compensation elements each designed to compensate for a corresponding state of the configurable antenna.

4. The circuit of claim 1, further comprising a second antenna coupled to another one of one of the first antenna port and the second antenna port, and a second phase shifting and impedance matching module interposed between the second antenna and the another one of one of the first antenna port and the second antenna port.

5. The circuit of claim 1, wherein the configurable antenna comprises a tunable multielement antenna.

6. The circuit of claim 1, wherein the configurable antenna comprises a tunable antenna having a movable antenna element.

7. The circuit of claim 1, wherein the control circuit performs the controlling, so as to cause variation of the at least one of amplitude and phase at an average period in a range of about 2 to 200 msec.

8. The circuit of claim 7, wherein the control circuit determines a periodicity of the variation of the at least one of amplitude and phase selected from the group consisting of: constant periodicity or variable periodicity.

9. The circuit of claim 7, wherein the control circuit communicates with a remote wireless communication device to determine a mutually beneficial periodicity for the variation of the at least one of amplitude and phase.

10. A method for operating a dual-antenna hybrid transmitter-receiver cancellation circuit, the method comprising:
varying at least one radiation pattern parameter of at least one configurable antenna of dual antennas in a hybrid transmitter-receiver cancellation circuit, so as to cause a corresponding change in at least one of amplitude and phase of a signal received at a receiver port of the circuit;
maintaining nearly constant impedance at the hybrid circuit's antenna interface ports; and
equalizing propagation delays between the hybrid circuit and both of the dual antennas.

11. The method of claim 10, wherein the varying comprises adjusting the radiation pattern parameter at least once per period, wherein the period is in a range of about 2 to 200 msec.

12. The method of claim 10, wherein the radiation pattern parameter comprises at least one of a radiation lobe direction, a radiation lobe shape, or a beam width.

13. The method of claim 10, wherein varying the at least one radiation pattern parameter comprises moving an antenna element.

14. The method of claim 10, wherein varying the at least one radiation pattern parameter comprises switching a connection between different antenna components and the receiver port.

15. The method of claim 10, further comprising selecting a periodicity of the varying the at least one radiation pattern parameter from the group consisting of:
constant periodicity or variable periodicity.

16. The method of claim 10, further comprising communicating with a second wireless communication device to determine a mutually beneficial periodicity for varying the at least one radiation pattern parameter.

17. A full-duplex transceiver comprising:
means for varying at least one radiation pattern parameter of at least one configurable antenna of dual antennas in a hybrid transmitter-receiver cancellation circuit, so as to cause a corresponding change in at least one of amplitude and phase of a signal received at a receiver port of the circuit;
means for maintaining nearly constant impedance at the hybrid circuit's antenna interface ports; and
means for equalizing propagation delays between the hybrid circuit and both of the dual antennas.

18. A full-duplex transceiver comprising:
at least one processor configured for:
varying at least one radiation pattern parameter of at least one configurable antenna of dual antennas in a hybrid transmitter-receiver cancellation circuit, so as to cause a corresponding change in at least one of amplitude and phase of a signal received at a receiver port of the circuit;
maintaining nearly constant impedance at the hybrid circuit's antenna interface ports; and
equalizing propagation delays between the hybrid circuit and both of the dual antennas; and
a memory coupled to the at least one processor for storing data.

19. The full-duplex transceiver of claim 18, wherein the processor is further configured to perform the varying by adjusting the radiation pattern parameter at least once per period, wherein the period is in a range of about 2 to 200 msec.

20. The full-duplex transceiver of claim 18, wherein the processor is further configured to vary the radiation pattern parameter thereby changing at least one of a radiation lobe direction, a radiation lobe shape, or a beam width.

21. The full-duplex transceiver of claim 20, wherein the processor is further configured to vary the at least one radiation pattern parameter by controlling movement of an antenna element.

22. The full-duplex transceiver of claim 18, wherein the processor is further configured to vary the at least one radiation pattern parameter by controlling switching a connection between different antenna components and the receiver port.

23. The full-duplex transceiver of claim 18, wherein the processor is further configured to select a periodicity of the varying the at least one radiation pattern parameter from the group consisting of: constant periodicity or variable periodicity.

24. The full-duplex transceiver of claim 18, wherein the processor is further configured to communicate with a second wireless communication device to determine a mutually beneficial periodicity for varying the at least one radiation pattern parameter.

25. A computer program product, comprising:
a computer-readable medium comprising code for causing a transceiver to:
vary at least one radiation pattern parameter of at least one configurable antenna of dual antennas in a hybrid transmitter-receiver cancellation circuit, so as to cause a corresponding change in at least one of amplitude and phase of a signal received at a receiver port of the circuit;
maintain nearly constant impedance at the hybrid circuit's antenna interface ports; and
equalize propagation delays between the hybrid circuit and both of the dual antennas.
